(19) United States
(12) Patent Application Publication
(10) Pub. No.: US 2018/0359086 A1
(43) Pub. Date: Dec. 13, 2018

(54) Quantum communication device, quantum communication system, and quantum communication method

(71) Applicant: Kabushiki Kaisha Toshiba, Minato-ku (JP)

(72) Inventors: Alex Dixon, Kawasaki (JP); Kazuaki Doi, Kawasaki (JP)

(73) Assignee: Kabushiki Kaisha Toshiba, Minato-ku (JP)

(21) Appl. No.: 15/932,199

(22) Filed: Feb. 16, 2018

(30) Foreign Application Priority Data
Jun. 13, 2017 (JP) 2017-116219

(51) Int. Cl. H04L 9/08; H04B 10/70

(52) U.S. Cl. CPC H04L 9/0858; H04L 1/0057; H04B 10/70

(57) ABSTRACT

According to an embodiment, a quantum communication device includes a corrector and a retransmission controller. The corrector is configured to generate corrected key data by performing error correction on received key data received from a transmitting device through a quantum channel. The retransmission controller is configured to transmit a retransmission request including retransmission target address information to the transmitting device through a control channel when a retransmission request condition is satisfied, and receive retransmission key data corresponding to the retransmission target address information from the transmitting device through the control channel. After receiving the retransmission key data, the corrector replaces corrected key data corresponding to the retransmission target address information with the retransmission key data.

### CROSS-REFERENCE TO RELATED APPLICATIONS

This application is based upon and claims the benefit of priority from Japanese Patent Application No. 2017-116219, filed on Jun. 13, 2017; the entire contents of which are incorporated herein by reference.

### FIELD

Embodiments described herein relate generally to a quantum communication device, a quantum communication system, and a quantum communication method.

### BACKGROUND

Developments in the information communication technology made it possible to send and receive various types of data. Accordingly, ensuring privacy and security in transmitting information has become of greater importance. Quantum cryptography has been introduced in communication technology as an encryption scheme that is unbreakable even if computers have enough computing power, and many efforts have been made for its practical implementation. One of the efforts to practically implement the quantum cryptography in the communication technology is, for example, to study error correction technologies, and various types of error correction technologies have been developed. Among them, low-density parity-check (LDPC) codes have recently attracted attention as an error correction code that has an error correction capability very close to the theoretical maximum (the Shannon limit).

In the conventional technologies, however, it is difficult to prevent lowering of the generation rate of a cryptographic key if error correction occurs frequently.

### BRIEF DESCRIPTION OF THE DRAWINGS

FIG. 1 is a diagram illustrating an example device configuration of a quantum communication system according to a first embodiment;

FIG. 2 is a diagram illustrating an example functional configuration of the quantum communication system according to the first embodiment;

FIG. 3 is a flowchart illustrating an example retransmission control process according to the first embodiment;

FIG. 4 is a diagram illustrating an example functional configuration of a quantum communication system according to a second embodiment;

FIG. 5 is a flowchart illustrating an example retransmission control process according to the second embodiment; and

FIG. 6 is a diagram illustrating an example hardware configuration of main units of a transmitting device and a receiver according to the first and the second embodiments.

### DETAILED DESCRIPTION

According to an embodiment, a quantum communication device includes a corrector and a retransmission controller. The corrector is configured to generate corrected key data by performing error correction on received key data received from a transmitting device through a quantum channel. The retransmission controller is configured to transmit a retransmission request including retransmission target address information to the transmitting device through a control channel when a retransmission request condition is satisfied, and receive retransmission key data corresponding to the retransmission target address information from the transmitting device through the control channel. After receiving the retransmission key data, the corrector replaces corrected key data corresponding to the retransmission target address information with the retransmission key data.

The following describes embodiments of a quantum communication device, a quantum communication system, and a quantum communication method with reference to the accompanying drawings.

### First Embodiment

Described first is a first embodiment.

Example Device Configuration

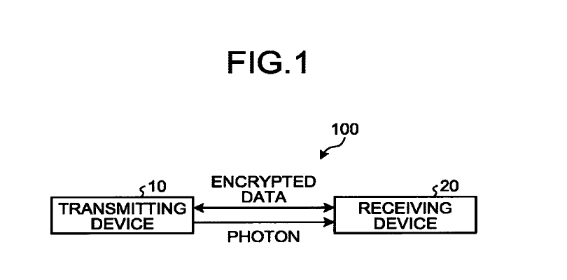

FIG. 1 is a diagram illustrating an example device configuration of a quantum communication system 100 according to the first embodiment. The quantum communication system 100 according to the first embodiment includes two quantum communication devices (a transmitting device 10 and a receiver 20). The transmitting device 10 sequentially transmits photons indicating quantum bits to the receiver 20. For convenience of explanation, the device that transmits photons is referred to as the transmitting device 10 in the first embodiment, but the transmitting device 10 may include a function of receiving photons. In the same manner, the receiver 20 may include a function of transmitting photons.

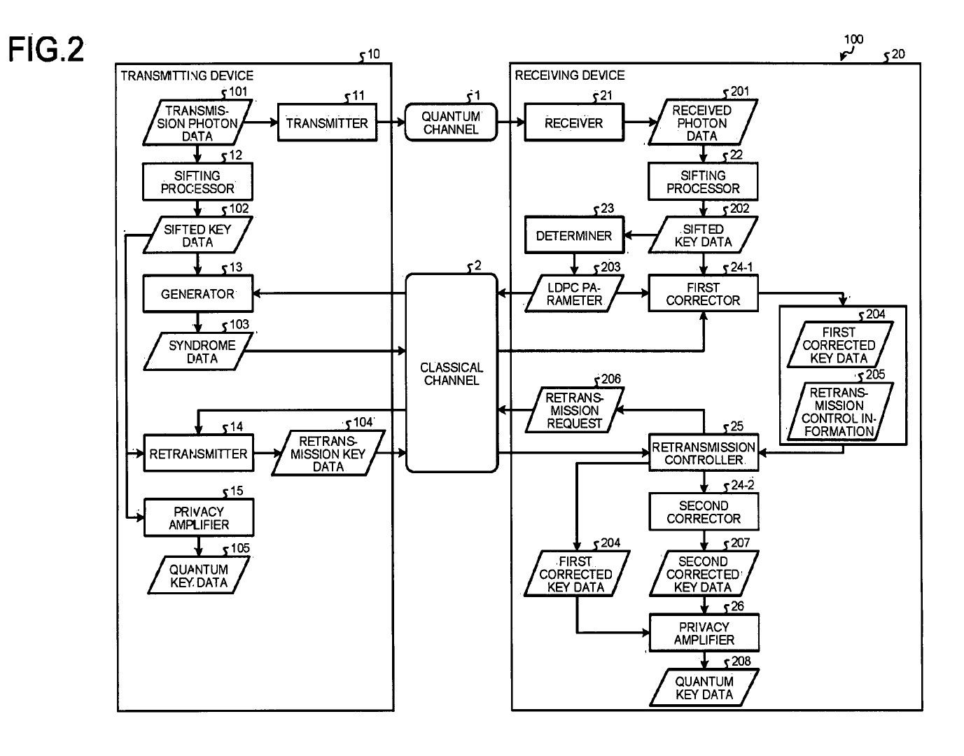

The transmitting device 10 and the receiver 20 transmit and receive encrypted data using quantum key data. The method of generating quantum key data will be described in detail below with reference to FIG. 2.

Example Functional Configuration

FIG. 2 is a diagram illustrating an example functional configuration of the quantum communication system 100 according to the first embodiment. The quantum communication system 100 according to the first embodiment includes the transmitting device 10 and the receiver 20.

The transmitting device 10 and the receiver 20 are connected with each other through a quantum channel 1. The quantum channel 1 is an optical fiber through which transmission photon data 101 indicating a quantum bit string is transmitted. The quantum channel 1 conveys single photons that are very weak light particles, thus susceptible to disturbance.

The transmitting device 10 and the receiver 20 are connected with each other through a classical channel 2. The classical channel 2 is a control channel through which control information for generating quantum key data 105 (208) is transmitted and received. As illustrated in FIG. 2, for example, the control information includes an LDPC parameter 203, syndrome data 103, a retransmission request 206, and retransmission key data 104. The classical channel 2 may be a wired channel or a wireless channel, and may be implemented by both wired and wireless channels.

The transmitting device 10 includes a transmitter 11, a sifting processor 12, a generator 13, a retransmitter 14, and a privacy amplifier 15.

The receiver 20 includes a receiver 21, a sifting processor 22, a determiner 23, a first corrector 24-1, a second corrector 24-2, a retransmission controller 25, and a privacy amplifier 26.

The transmitter 11 transmits the transmission photon data 101 to the receiver 21 through the quantum channel 1. The quantum bits configuring the transmission photon data 101 are each expressed by one of a plurality of bases using the quantum states of the photon. For the bases, properties of the photon such as its polarization or phase are used.

The receiver 21 receives the transmission photon data 101 from the transmitter 11 through the quantum channel 1, thereby acquiring received photon data 201.

The sifting processor 22 performs a sifting process in which the sifting processor 22 refers to the received photon data 201 for each certain bit string in reference bases randomly selected from a plurality of bases and acquires sifted key data 202 (received key data). The sifting processor 22 inputs the sifted key data 202 to the determiner 23 and to the first corrector 24-1.

Meanwhile, the sifting processor 12 in the transmitting device 10 performs the sifting process on the transmission photon data 101 and acquires sifted key data 102. The sifting processor 12 inputs the sifted key data 102 to the generator 13 and to the privacy amplifier 15. When the retransmitter 14 receives a retransmission request 206 from the receiver 20, the sifting processor 12 inputs data, out of the sifted key data 102, specified by the retransmission request 206 to the retransmitter 14.

Upon reception of the sifted key data 202 from the sifting processor 22, the determiner 23 in the receiver 20 determines an LDPC parameter 203 for use in error correction on the sifted key data 202. The LDPC parameter 203 may be determined by any method. The determiner 23 determines the LDPC parameter 203 by using, for example, an error rate of the previously received sifted key data 202 computed in the previous error correction. The determiner 23 transmits the LDPC parameter 203 to the generator 13 in the transmitting device 10 through the classical channel 2.

The generator 13 in the transmitting device 10 receives the LDPC parameter 203 from the determiner 23 in the receiver 20 and receives the sifted key data 102 from the sifting processor 12. The generator 13 generates syndrome data 103 from the sifted key data 102 by using the LDPC parameter 203. The generator 13 transmits the syndrome data 103 to the first corrector 24-1 in the receiver 20 through the classical channel 2.

The first corrector 24-1 in the receiver 20 receives the syndrome data 103 from the generator 13 in the transmitting device 10, receives the LDPC parameter 203 from the determiner 23, and receives the sifted key data 202 from the sifting processor 22.

The first corrector 24-1 divides the sifted key data 202 into one or more error correction blocks and performs error correction on each error correction block. The first corrector 24-1 is implemented by, for example, an LDPC decoder. The first corrector 24-1 uses the syndrome data 103 and the LDPC parameter 203 to perform error correction on the sifted key data 202 (one or more error correction blocks), thereby generating first corrected key data 204 and retransmission control information 205.

The first corrected key data 204 is binary data converted from a posterior value (analog value) of the sifted key data 202. The posterior value is computed upon execution of error correction (LDPC decoding). The posterior value is a log-likelihood ratio between a posterior probability that the data included in the sifted key data 202 is 1 and a posterior probability that the data included in the sifted key data 202 is 0, as a result of LDPC decoding. When the posterior value is positive, the probability that the data is 1 is higher, whereas when the posteriori value is negative, the probability that the data is 0 is higher. When the posterior value is zero or greater, the first corrector 24-1 sets the data corresponding to the posterior value to be 1, and when the posterior value is smaller than zero, the first corrector 24-1 sets the data corresponding to the posterior value to be 0, and generates the first corrected key data 204 from the sifted key data 202.

The retransmission control information 205 is information for use in retransmission control of the retransmission controller 25. The retransmission control information 205 includes, for example, success/failure information and an error rate.

The success/failure information indicates success or failure in error correction for each error correction block. For example, the success/failure information indicates success when it is 1, and indicates failure when it is 0. The error rate indicates the error rate of the sifted key data 202. The error rate of the sifted key data 202 is computed by comparing the first corrected key data 204 with the sifted key data 202 when the error correction on the one or more error correction blocks is successfully performed.

The first corrector 24-1 inputs the first corrected key data 204 and the retransmission control information 205 to the retransmission controller 25.

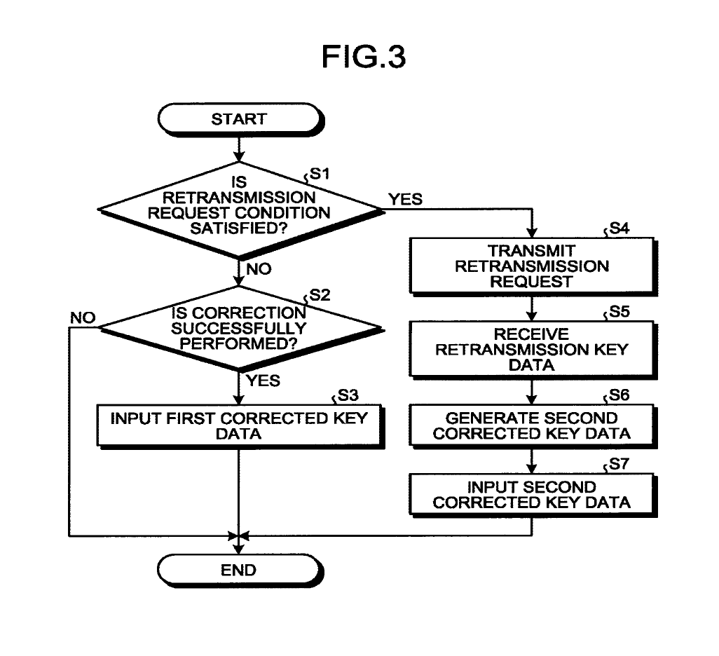

The retransmission controller 25 receives the first corrected key data 204 and the retransmission control information 205 from the first corrector 24-1. The retransmission controller 25 refers to the retransmission control information 205 to determine whether a retransmission request condition is satisfied. Details of the retransmission request condition will be described later with reference to FIG. 3.

When the retransmission request condition is not satisfied and when all the error correction blocks that are the divided portions of the sifted key data 202 are successfully error corrected, the retransmission controller 25 inputs the first corrected key data 204 to the privacy amplifier 26.

When the retransmission request condition is satisfied, the retransmission controller 25 transmits the retransmission request 206 to the transmitting device 10 through the classical channel 2.

The retransmission request 206 includes retransmission target address information. The retransmission target address information according to the first embodiment indicates the entire address of each unsuccessfully error corrected block.

Upon reception of the retransmission request 206 from the retransmission controller 25 in the receiver 20, the retransmitter 14 in the transmitting device 10 acquires data specified by the retransmission target address information included in the retransmission request 206 from the sifted key data 102 and transmits the data to the retransmission controller 25 as retransmission key data 104.

Upon reception of the retransmission key data 104 from the transmitting device 10 through the classical channel 2, the retransmission controller 25 inputs the retransmission key data 104 and the first corrected key data 204 to the second corrector 24-2.

Upon reception of the retransmission key data 104 and the first corrected key data 204 from the retransmission controller 25, the second corrector 24-2 replaces data (error correction blocks in the first embodiment) corresponding to the retransmission target address information with the retransmission key data 104, thereby correcting the first corrected key data 204. The second corrector 24-2 inputs second corrected key data 207, which is generated by correcting the first corrected key data 204, to the privacy amplifier 26.

Although FIG. 2 illustrates the first corrector 24-1 and the second corrector 24-2 as units for performing error correction, the first corrector 24-1 and the second corrector 24-2 may be implemented by a single corrector.

Upon reception of the first corrected key data 204 from the retransmission controller 25, the privacy amplifier 26 performs privacy amplification on the first corrected key data 204 and generates quantum key data 208. In the same manner, upon reception of the second corrected key data 207 from the second corrector 24-2, the privacy amplifier 26 performs privacy amplification on the second corrected key data 207 and generates the quantum key data 208.

The privacy amplification is a process of amplifying privacy in generating the quantum key data 208 by compressing the first corrected key data 204 or the second corrected key data 207.

Meanwhile, upon reception of the sifted key data 102 from the sifting processor 12, the privacy amplifier 15 in the transmitting device 10 performs privacy amplification on the sifted key data 102 and generates quantum key data 105 that is identical to the quantum key data 208.

FIG. 3 is a flowchart illustrating an example retransmission control process according to the first embodiment. First, the retransmission controller 25 determines whether the retransmission request condition is satisfied (Step S1). Details of the retransmission request condition will be described later.

If the retransmission request condition is not satisfied (No at Step S1), the retransmission controller 25 determines whether all the error correction blocks that are the divided portions of the sifted key data 202 have been successfully error corrected (Step S2).

If all the error correction blocks have been successfully error corrected (Yes at Step S2), the retransmission controller 25 inputs the first corrected key data 204 to the privacy amplifier 26 (Step S3).

If not all the error correction blocks have been successfully error corrected (No at Step S2), the procedure is ended. In this case, the first corrected key data 204 is not input to the privacy amplifier 26, and the sifted key data 102 is not input to the privacy amplifier 15. In other words, when the error correction is unsuccessfully performed and the retransmission request condition is not satisfied, the procedure is ended.

If the retransmission request condition is satisfied (Yes at Step S1), the retransmission controller 25 transmits the retransmission request 206 to the transmitting device 10 through the classical channel 2 (Step S4). The retransmission controller 25 then receives the retransmission key data 104 from the transmitting device 10 through the classical channel 2 (Step S5). The second corrector 24-2 replaces data of unsuccessfully error corrected blocks included in the first corrected key data 204 with the retransmission key data 104 to generate second corrected key data 207 (Step S6). The second corrector 24-2 inputs the second corrected key data 207 to the privacy amplifier 26 (Step S7).

Described next are details of the retransmission request condition. The retransmission request condition includes, for example, Conditions (1) and (2) below.

Condition (1): There is an error correction block that has been unsuccessfully error corrected.

Condition (2): The sum of data lengths of the retransmission key data 104 is smaller than a certain value.

Description of Condition (1)

Condition (1) is a retransmission request condition that can be used in, for example, automatic repeat request (ARQ) protocols. Using Condition (1) as the retransmission request condition can reduce the probability of failure in error correction, thereby preventing lowering of the key generation rate caused by the correction failure. In particular, this configuration has a significant improving effect in executing an error correction instruction compared to a case in which data is divided into a plurality of error correction blocks and, when not all of the error correction blocks are successfully error corrected, the entire first corrected key data 204 is discarded.

Suppose that, for example, the first corrector 24-1 divides the sifted key data 202 into ten error correction blocks upon execution of an error correction instruction and transmits the sifted key data 202 to the privacy amplifier 26 only when all of the error correction blocks are successfully error corrected. In this case, when Condition (1) is not used in the retransmission control scheme, the entire data of the ten error corrected blocks is discarded upon failure in error correction on a single block.

Meanwhile, when Condition (1) is used in the retransmission control scheme, the second corrector 24-2 replaces data of unsuccessfully error corrected blocks included in the first corrected key data 204 with the retransmission key data 104 and generates the second corrected key data 207, and the second corrected key data 207 is transmitted to the privacy amplifier 26. The retransmission key data 104 is transmitted through the classical channel 2, and thus the retransmission key data 104 is publicized in a common network. In this regard, the privacy amplifier 26 increases the compression rate in the privacy amplification in accordance with the data length of the retransmission key data 104, thereby ensuring privacy of the quantum key data 208.

Description of Condition (2)

Condition (2) relates to the size of data publicly transmitted in the classical channel 2 in executing the error correction and to a compression rate in the privacy amplification. In the error correction according to the first embodiment, the syndrome data 103 and the retransmission key data 104 are transmitted through the classical channel 2, and thus the syndrome data 103 and the retransmission key data 104 are publicized.

The compression rate in the privacy amplification increases as the amount of data publicly transmitted is larger, and when the amount of data equates to a certain value T or greater, the compression rate will be zero or below zero. Let the data length of public data with which the compression rate in privacy amplification will be zero be L, and let the syndrome length in error correction be S, the certain value T is expressed as L−S. The data length L of the public data is determined in accordance with the error rate of the sifted key data 202.

In the first embodiment, the data length of the retransmission key data 104 is a sum of data lengths of all the data of the unsuccessfully error corrected blocks. When the sum is smaller than the certain value T, the retransmission controller 25 performs the retransmission process, whereas when the sum is the certain value T or greater, the retransmission controller 25 does not perform the retransmission process.

Adding Condition (2) to Condition (1) can prevent the retransmission controller 25 from performing useless retransmission processes, thereby increasing the generation rate of the quantum key data 208.

When, for example, most of the ten error correction blocks are incorrect and the retransmission process is performed, the data length L of the public data will be large. Thus, the compression rate in the privacy amplification will be zero or below zero, which will make the retransmission process useless, and thus, the retransmission controller 25 does not perform the retransmission process.

Described next is the detail of the computation method of the certain value T. Lucamarini discloses the following Equation (1) as an equation for computing a compression rate r for use in privacy amplification.

r=H_{ξ}_{_{PE}}(A∥E)−(leak_{EC}+Δ)/n (1)

The first term on the right-hand side of Equation (1) indicates to which extent the eavesdropper eavesdrops on the transmission photon data 101 transmitted from the transmitter 11. When the first term on the right-hand side of Equation (1) is zero, it indicates that the eavesdropper eavesdrops on all the transmission photon data 101. When the first term on the right-hand side of Equation (1) is one, it indicates that the eavesdropper eavesdrops on no transmission photon data 101. The first term on the right-hand side of Equation (1) is computed based on, for example, an error rate of the sifted key data 202, and is closer to zero as the error rate increases.

The term leak_{EC} in Equation (1) accounts for the amount of data publicly transmitted through the classical channel 2 during error correction. As described above, in the first embodiment, the syndrome data 103 and the retransmission key data 104 are publicly transmitted through the classical channel 2. The amount of leak_{EC} increases as the sum of the data length of the syndrome data 103 and the data length of the retransmission key data 104 increases, which results in a smaller compression rate r.

In Equation (1), Δ represents data indicating the finite length effect of the quantum key data 208. An error rate Q of the sifted key data 202 can be obtained by comparing the error correction blocks that are successfully error corrected with data corresponding to these error correction blocks in the sifted key data 202. Once the error rate Q of the sifted key data is obtained, the value of leak_{EC} and the data length L with which the compression rate r will be zero can be obtained from Equation (1) and the error rate Q. Thus, the certain value T can be obtained from L−S as described above.

The retransmission controller 25 may use, for example, Condition (1) as the retransmission request condition. The retransmission controller 25 may use, for example, both Conditions (1) and (2) as the retransmission request condition.

The error correction in the first embodiment is described as decoding of LDPC codes, for example, but the error correction is not limited to LDPC decoding. The error correction may be, for example, decoding of Bose-Chaudhuri-Hocquenghem (BCH) codes or decoding of Reed-Solomon (RS) codes.

As described above, in the receiver 20 (quantum communication device) according to the first embodiment, the first corrector 24-1 performs error correction on the sifted key data 202 (received key data) received from the transmitting device 10 through the quantum channel 1 and generates the first corrected key data 204. When the retransmission request condition is satisfied, the retransmission controller 25 transmits the retransmission request 206 including the retransmission target address information (in the first embodiment, the entire address of each error correction block that has been unsuccessfully error corrected) to the transmitting device 10 through the classical channel 2 (control channel), and receives the retransmission key data 104 corresponding to the retransmission target address information from the transmitting device 10 through the classical channel 2. The second corrector 24-2 replaces corrected key data corresponding to the retransmission target address information with the retransmission key data 104, thereby correcting the first corrected key data 204.

The first corrector 24-1 and the second corrector 24-2 may be implemented by a single corrector.

The receiver 20 according to the first embodiment can prevent lowering of the generation rate of a cryptographic key if failures in error correction occur frequently.

### Second Embodiment

Described next is a second embodiment. In the description of the second embodiment, explanations similar to the first embodiment are omitted and differences from the first embodiment are described. In the first embodiment, the whole data of unsuccessfully error corrected blocks is retransmitted. In the second embodiment, however, the retransmission key data 104 to be retransmitted does not include the whole data of the unsuccessfully error corrected blocks, but includes part of data included in the unsuccessfully error corrected blocks. This configuration can reduce the amount of data on which the eavesdropper may eavesdrop in the classical channel 2.

Example Functional Configuration

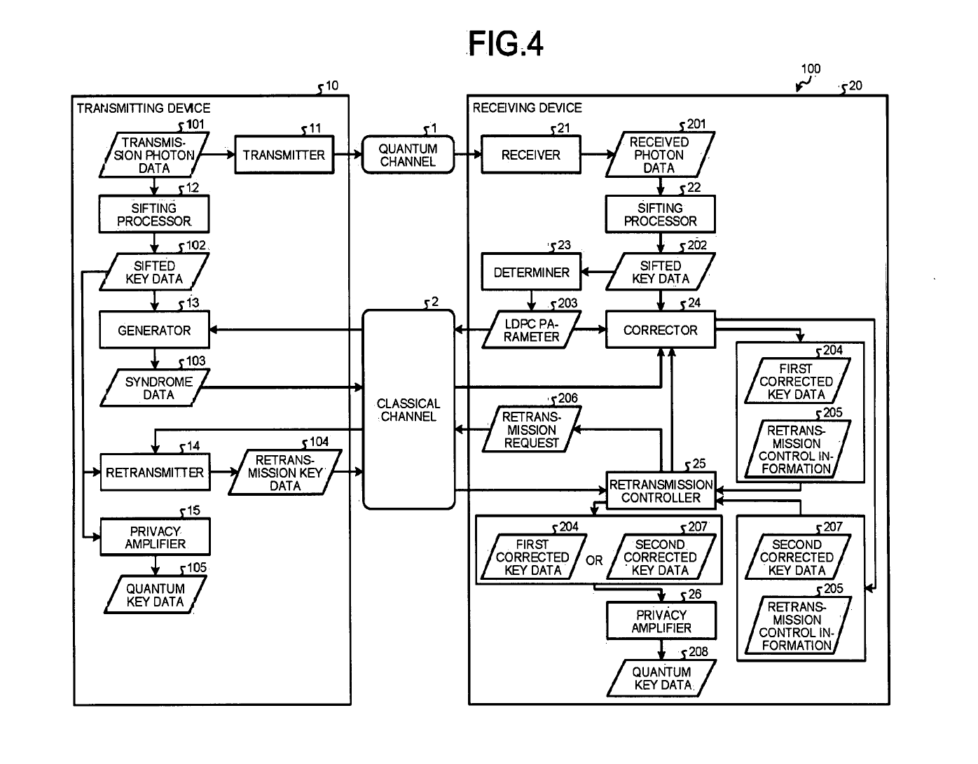

FIG. 4 is a diagram illustrating an example functional configuration of a quantum communication system 100 according to the second embodiment. The quantum communication system 100 according to the second embodiment includes the transmitting device 10 and the receiver 20. The transmitting device 10 and the receiver 20 are connected with each other through the quantum channel 1. The transmitting device 10 and the receiver 20 are connected with each other through the classical channel 2.

The transmitting device 10 includes the transmitter 11, the sifting processor 12, the generator 13, the retransmitter 14, and the privacy amplifier 15. The receiver 20 includes the receiver 21, the sifting processor 22, the determiner 23, a corrector 24, the retransmission controller 25, and the privacy amplifier 26.

The second embodiment differs from the first embodiment in the operations of the corrector 24 and the retransmission controller 25, and thus, the description of the second embodiment will focus on the operations of the corrector 24 and the retransmission controller 25.

The corrector 24 refers to the LDPC parameter 203 and the syndrome data 103 to correct errors in the sifted key data 202. The corrector 24 inputs the first corrected key data 204 and the retransmission control information 205 to the retransmission controller 25.

The retransmission control information 205 according to the second embodiment includes reliability information in addition to the success/failure information and the error rate described above. The reliability information indicates reliability of the first corrected key data 204 or the second corrected key data 207. The reliability information is computed from the posterior value (log-likelihood ratio) described above. A greater absolute value of the posterior value means a higher probability that the data included in the sifted key data 202 is 0 or that the data is 1, thus indicating a higher reliability of the data. In this regard, a threshold is set for the absolute value of the posterior value, and when the absolute value is below the threshold, the retransmission controller 25 determines that the data is not reliable. In other words, data, out of data included in each unsuccessfully error corrected block, determined to be unreliable will be the retransmission target data.

In this paragraph, the threshold of the posterior value will be considered. The posterior value is a log-likelihood ratio between the posterior probability that the data included in the sifted key data 202 is 1 and the posterior probability that the data included in the sifted key data 202 is 0. Suppose that, for example, the higher one of the posterior probabilities is 90% or greater and the lower one is 10% or smaller, and that the data is reliable, the threshold for the absolute value of the posterior value is 2.197(≈log(0.9/0.1)=|log(0.1/0.9)|). Accordingly, when the absolute value of the posterior value is 2.197 or greater, the retransmission controller 25 determines that the data corresponding to the posterior value is reliable. When the absolute value of the posterior value is smaller than 2.197, the retransmission controller 25 determines that the data corresponding to the posterior value is not reliable.

The retransmission controller 25 receives the first corrected key data 204 and the retransmission control information 205 from the corrector 24. When the retransmission request condition is satisfied, the retransmission controller 25 determines the address of data reliability of which is below the threshold in each unsuccessfully error corrected block to be the retransmission target address information, and transmits the retransmission request 206 including the retransmission target address information to the transmitting device 10 through the classical channel 2.

Upon reception of the retransmission requect 206 from the retransmission controller 25 in the receiver 20, the retransmitter 14 in the transmitting device 10 acquires the data specified by the retransmission target address information included in the retransmission request 206 from the sifted key data 102 and transmits the data to the retransmission controller 25 as the retransmission key data 104.

Upon reception of the retransmission key data 104 from the transmitting device 10 through the classical channel 2, the retransmission controller 25 inputs the retransmission key data 104 to the corrector 24.

Upon reception of the retransmission key data 104 from the retransmission controller 25, the corrector 24 replaces data, out of the data included in the first corrected key data 204, corresponding to the retransmission key data 104 with the retransmission key data 104, and generates replaced data. The corrector 24 then refers to the LDDC parameter 203 and the syndrome data 103 and performs error correction on the replaced data, thereby generating the second corrected key data 207 and the retransmission control information 205.

Upon reception of the second corrected key data 207 and the retransmission control information 205 from the corrector 24, the retransmission controller 25 performs the retransmission control process again. The retransmission controller 25 repeats the retransmission control process until the retransmission request condition is no longer satisfied. When the retransmission request condition is not satisfied, the retransmission controller 25 inputs the first corrected key data 204 generated through a single error correction process, or the second corrected key data 207 generated through two or more error correction processes to the privacy amplifier 26. Differences between the first embodiment and the second embodiment have been described.

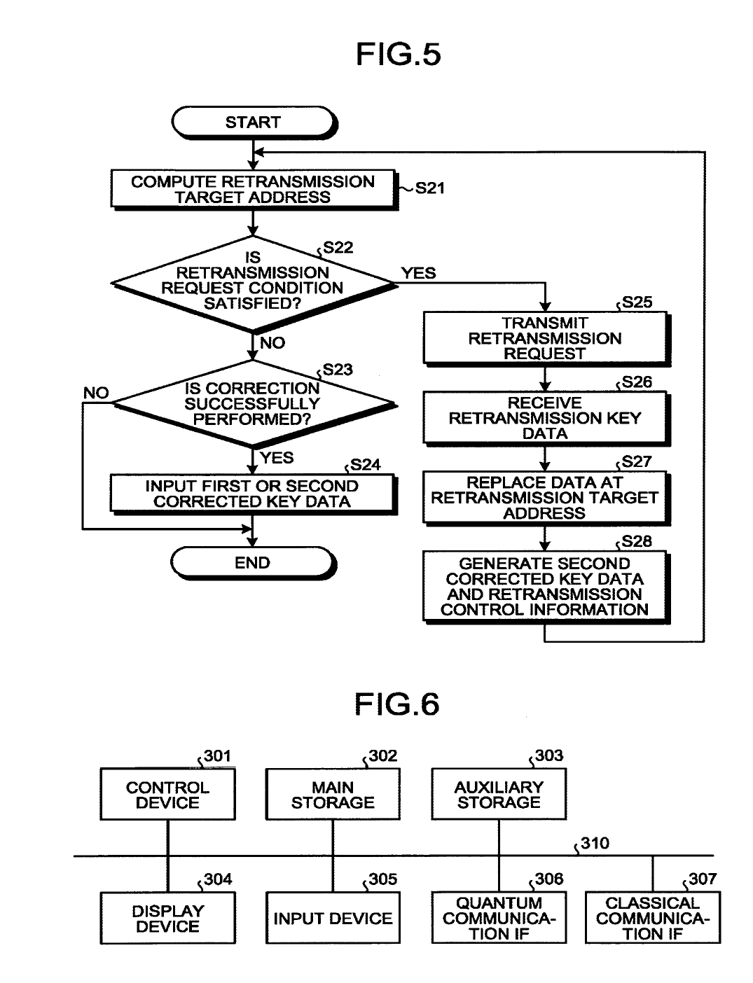

FIG. 5 is a flowchart illustrating an example retransmission control process according to the second embodiment. First, the retransmission controller 25 refers to the retransmission control information 205 (success/failure information and reliability information) described above, and computes address information indicating the address of data included in each unsuccessfully error corrected block, the data reliability of which is below the threshold, as the retransmission target address (Step S21).

The retransmission controller 25 then determines whether the aforementioned retransmission request condition is satisfied (Step S22). Condition (1) is the same as the condition described in the first embodiment. That is, if there is an error correction block that has been unsuccessfully error corrected, the retransmission controller 25 requests retransmission. Condition (2) is basically the same as the condition described in the first embodiment. In the second embodiment, the retransmission controller 25 may request retransmission a plurality of times. In this regard, when the sum of data lengths of the retransmission key data 104 that has been retransmitted so far is smaller than the certain value T, the retransmission controller 25 requests retransmission. With regard to the retransmission request condition, there are two possible combinations, a combination composed of Condition (1) and a combination composed of Conditions (1) and (2), in the same manner as in the first embodiment.

If the retransmission request condition is not satisfied (No at Step S22), the retransmission controller 25 determines whether all the error correction blocks that are the divided portions of the sifted key data 202 have been successfully error corrected (Step S23).

If all the error correction blocks have been successfully error corrected (Yes at Step S23), the retransmission controller 25 inputs the first corrected key data 204 or the second corrected key data 207 to the privacy amplifier 26 (Step S24).

If not all the error correction blocks are successfully error corrected (No at Step S23), the procedure is ended. In this case, the first corrected key data 204 or the second corrected key data 207 is not input to the privacy amplifier 26, and the sifted key data 102 is not input to the privacy amplifier 15. In other words, if the error correction is unsuccessfully performed and the retransmission request condition is not satisfied, the procedure is ended.

If the retransmission request condition is satisfied (Yes at Step S22), the retransmission controller 25 transmits the retransmission request 206 to the transmitting device 10 through the classical channel 2 (Step S25). The retransmission controller 25 then receives the retransmission key data 104 from the transmitting device 10 through the classical channel 2 (Step S26). Subsequently, the corrector replaces data (data at the retransmission target address) included in the data of each unsuccessfully error corrected block of the first corrected key data 204 with the retransmission key data 104, and generates replaced data (Step S27). The corrector 24 then refers to the LDPC parameter 203 and the syndrome data 103 and performs error correction on the replaced data, thereby generating the second corrected key data 207 and the retransmission control information 205 (Step S28). The procedure returns to Step S21.

From the second round of the procedure, the replaced data is generated at Step S27 by replacing data (data at the retransmission target address) included in the data of each unsuccessfully error corrected block of the second corrected key data 207 with the retransmission key data 104.

As described above, in the receiver 20 (quantum communication device) according to the second embodiment, the corrector 24 performs error correction on the sifted key data 202 (received key data) received from the transmitting device 10 through the quantum channel 1 and generates the first corrected key data 204. When the retransmission request condition is satisfied, the retransmission controller 25 transmits the retransmission request 206 including the retransmission target address information (in the second embodiment, an address of unreliable data in each unsuccessfully error corrected block) to the transmitting device 10 through the classical channel 2 (control channel), and receives the retransmission key data 104 corresponding to the retransmission target address information from the transmitting device 10 through the classical channel 2. The corrector 24 replaces corrected key data at the retransmission target address with the retransmission key data 104 to generate replaced data, and further corrects the replaced data.

The receiver 20 according to the second embodiment can prevent lowering of the generation rate of a cryptographic key if failures in error correction occur frequently. The receiver 20 according to the second embodiment can reduce the amount of data on which the eavesdropper may eavesdrop through the classical channel 2 compared to the first embodiment.

Lastly, an example hardware configuration of the transmitting device 10 and the receiver 20 according to the first and the second embodiments will be described.

Example Hardware Configuration

FIG. 6 is a diagram illustrating an example hardware configuration of main units of the transmitting device 10 and the receiver 20 according to the first and the second embodiments. The transmitting device 10 and the receiver 20 according to the first and the second embodiments each include a control device 301, a main storage 302, a auxiliary storage 303, a display device 304, an input device 305, a quantum communication interface (IF) 306, and a classical communication IF 307.

The control device 301, the main storage 302, the auxiliary storage 303, the display device 304, the input device 305, the quantum communication IF 306, and the classical communication IF 307 are connected with each other through a bus 310.

The control device 301 executes a computer program read from the auxiliary storage 303 onto the main storage 302.

The main storage 302 may include, for example, a read only memory (ROM) and a random access memory (RAM). The auxiliary storage 303 may include, for example, a hard disk drive (HDD) and a memory card.

The display device 304 displays, for example, states of the transmitting device 10 and the receiver 20. The input device 305 receives inputs from a user.

The quantum communication IF 306 is an interface for connecting to the quantum channel 1. The classical communication IF 307 is an interface for connecting to the classical channel 2.

The transmitting device 10 and the receiver 20 according to the first and the second embodiments can be implemented by any device such as a general-purpose computer including the hardware configuration illustrated in FIG. 6.

The computer program executed by the transmitting device 10 and the receiver 20 according to the first and the second embodiments above is recorded in a computer-readable recording medium such as a compact disc read only memory (CD-ROM), a memory card, a compact disc recordable (CD-R), and a digital versatile disc (DVD), as an installable or executable file, and provided as a computer program product.

The computer program executed by the transmitting device 10 and the receiver 20 according to the first and the second embodiments above may be stored in a computer connected to a network such as the Internet and provided by being downloaded through the network.

Furthermore, the computer program executed by the transmitting device 10 and the receiver 20 according to the first and the second embodiments above may be provided through a network such as the Internet without being downloaded.

The computer program executed by the transmitting device 10 and the receiver 20 according to the first and the second embodiments above may be embedded and provided in a ROM, for example.

The computer program executed by the transmitting device 10 and the receiver 20 according to the first and the second embodiments above has a modular configuration including a function, out of the functions of the transmitting device 10 and the receiver 20 according to the first and the second embodiments, that can be implemented by the computer program.

The function implemented by the computer program is implemented such that the control device 301 reads the computer program from a storage medium such as the auxiliary storage 303 and executes it, and the function is loaded on the main storage 302. In other words, the function implemented by the computer program is generated on the main storage 302.

Some or all of the functions of the transmitting device 10 and the receiver 20 according to the first and the second embodiments above may be implemented by hardware such as an integrated circuit (IC). The IC is a processor that performs, for example, specialized processing.

When the functions are implemented by a plurality of processors, each processor may implement a single function, or may implement two or more functions.

The transmitting device 10 and the receiver 20 according to the first and the second embodiments above may be operated in any way. The transmitting device 10 and the receiver 20 according to the first and the second embodiments above may be operated, for example, as devices that configure a cloud system on a network.

According to the quantum communication device, the quantum communication system, and the quantum communication method of at least one embodiment described above, it is possible to prevent lowering of the generation rate of a cryptographic key if failures in error correction occur frequently.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A quantum communication device comprising:
a corrector configured to generate corrected key data by performing error correction on received key data received from a transmitting device through a quantum channel; and
a retransmission controller configured to
transmit a retransmission request including retransmission target address information to the transmitting device through a control channel when a retransmission request condition is satisfied, and
receive retransmission key data corresponding to the retransmission target address information from the transmitting device through the control channel, wherein
after receiving the retransmission key data, the corrector replaces corrected key data corresponding to the retransmission target address information with the retransmission key data.

2. The device according to claim 1, wherein the corrector divides the received key data into a plurality of error correction blocks and performs error correction on each error correction block.

3. The device according to claim 2, wherein the retransmission target address information indicates an entire address of an error correction block that has been unsuccessfully error corrected.

4. The device according to claim 2, wherein
the corrector is a low-density parity-check (LDPC) decoder configured to output information indicating success or failure in error correction on each error correction block, corrected key data of each error correction block, and reliability of data included in the corrected key data,
the retransmission target address information indicates an address of data reliability of which is below a threshold, the data being included in an error correction block that has been unsuccessfully error corrected, and
after receiving the retransmission key data, the corrector replaces corrected key data corresponding to the retransmission target address information with the retransmission key data to generate replaced data, and performs error correction on the replaced data.

5. The device according to claim 4, wherein the reliability is an absolute value of a log-likelihood ratio between a posterior probability that data included in the received key data is 1 and a posterior probability that data included in the received key data is 0.

6. The device according to claim 2, wherein the retransmission request condition is that there is an error correction block that has been unsuccessfully error corrected.

7. The device according to claim 1, wherein the retransmission request condition is that a sum of data lengths of the retransmission key data is smaller than a certain value.

8. The device according to claim 7, wherein the certain value is a difference between a data length of public data, the data length with which a compression rate in privacy amplification performed after the error correction is zero, and a data length of syndrome data transmitted in the error correction.

9. A quantum communication system comprising:
a transmitting device; and
a receiving device connected with the transmitting device through a quantum channel, wherein
the receiving device includes
a corrector configured to generate corrected key data by performing error correction on received key data received from the transmitting device through the quantum channel; and
a retransmission controller configured to
transmit a retransmission request including retransmission target address information to the transmitting device through a control channel when a retransmission request condition is satisfied, and
receive retransmission key data corresponding to the retransmission target address information from the transmitting device through the control channel, and
after receiving the retransmission key data, the corrector replaces corrected key data corresponding to the retransmission target address information with the retransmission key data.

10. A quantum communication method comprising:
generating corrected key data by performing error correction on received key data received from a transmitting device through a quantum channel;
transmitting a retransmission request including retransmission target address information to the transmitting device through a control channel when a retransmission request condition is satisfied, and receiving retransmission key data corresponding to the retransmission target address information from the transmitting device through the control channel; and
replacing corrected key data corresponding to the retransmission target address information with the retransmission key data.
